(19) United States
(12) Patent Application Publication
(10) Pub. No.: US 2014/0051608 A1
(43) Pub. Date: Feb. 20, 2014

(54) Wellbore Servicing Compositions and Methods of Making and Using Same

(71) Applicants: Rajesh Kumar SAINI, Cypress, TX (US); Jeremy HOLTSCLAW, Kingwood, TX (US)

(72) Inventors: Rajesh Kumar SAINI, Cypress, TX (US); Jeremy HOLTSCLAW, Kingwood, TX (US)

(73) Assignee: HALLIBURTON ENERGY SERVICES, INC., Houston, TX (US)

(21) Appl. No.: 13/586,109

(22) Filed: Aug. 15, 2012

(51) Int. Cl. C09K 8/56; C09K 8/00; C09K 8/62; C09K 8/035; C09K 8/40

(52) U.S. Cl. 507/130; 507/242; 507/219

(57) ABSTRACT

A method of servicing a wellbore, comprising placing a wellbore servicing fluid comprising a transiently functional additive into a wellbore, wherein the transiently functional additive is a Diels-Alder reaction product. A method of servicing a wellbore comprising placing into a wellbore a wellbore servicing fluid comprising the reaction product of furan and maleimide. A consolidation fluid comprising a resin and the reaction product of furan and maleimide.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

The present disclosure generally relates to wellbore servicing. More specifically, this disclosure relates to transiently functional additives for use in wellbore servicing fluids.

2. Background

A natural resource such as oil or gas residing in a subterranean formation can be recovered by drilling a well into the formation. The subterranean formation is usually isolated from other formations using a technique known as zonal isolation. In particular, a wellbore is typically drilled down to the subterranean formation while circulating a drilling fluid through the wellbore. After the drilling is terminated, a string of pipe, e.g., casing, is run in the wellbore. Primary cementing is then usually performed whereby a cement slurry is pumped down through the string of pipe and into the annulus between the string of pipe and the walls of the wellbore to allow the cement slurry to set into an impermeable cement column and thereby seal the annulus. Subsequently, oil or gas residing in the subterranean formation may be recovered by driving a fluid into the well using, for example, a pressure gradient that exists between the formation and the wellbore, the force of gravity, displacement of the fluid using a pump or the force of another fluid injected into the well or an adjacent well.

Fluids used in servicing a wellbore often include additives which function to improve one or more physical and/or mechanical properties of the fluid. Once the fluids have been utilized in the wellbore servicing operation the additive's function may no longer be necessary. In some instances, the additives after having served their intended function may adversely impact subsequent wellbore servicing operations were they to remain active within the wellbore. Thus, an ongoing need exists for additives having transient activity and methods of making and using same.

### SUMMARY

Disclosed herein is a method of servicing a wellbore comprising placing a wellbore servicing fluid comprising a transiently functional additive into a wellbore, wherein the transiently functional additive is a Diels-Alder reaction product.

Also disclosed herein is a method of servicing a wellbore comprising placing into a wellbore a wellbore servicing fluid comprising the reaction product of furan and maleimide.

Also disclosed herein is a consolidation fluid comprising a resin and the reaction product of furan and maleimide.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are compositions and methods for servicing a wellbore. In an embodiment, the composition comprises a wellbore servicing fluid (WSF) and a transiently functional additive. Herein the transiently functional additive confers to the wellbore servicing fluid one or more desirable properties for a time period sufficient to meet some user and/or process designated or desired goal. Subsequent to the user and/or process goal being met and/or the time period associated with same having lapsed, the transiently functional additive may lose the ability to function in its original capacity.

In an embodiment, the transiently functional additive comprises a surfactant. Surfactants, as that term is used herein, refer to surface-active agents that are usually organic and whose molecules contain a hydrophilic group at one end and a lipophilic group at the other. Surfactants often act as wetting agents that are capable of reducing the surface tension of a liquid in which it is dissolved. Wetting refers to the ability of a liquid to maintain contact with a solid surface, resulting from intermolecular interactions when the two are brought together. The degree of wetting (wettability) is determined by a force balance between adhesive and cohesive forces.

A surfactant suitable for use in this disclosure as a transiently functional additive is a cleavable surfactant for example a thermally cleavable surfactant. Herein a cleavable surfactant refers to a molecule that undergoes a degradation that is a chemical or physical change of the parent molecular structure resulting in a change and/or loss of the surface-active behavior. In an embodiment, the thermally cleavable surfactant comprises the product of a cycloaddition reaction which may have one or more desirable properties, such as the ability to perform its intended function for a time period followed by its subsequent degradation, i.e., loss of function. Non-limiting examples of cycloaddition reactions whose product(s) may be suitably employed as a transiently functional additive in this disclosure include Diels-Alder reactions (i.e., [4+2] cycloadditions), inverse electron demand Diels-Alder reaction, “click chemistry”-type additions, Huisgen cycloadditions (i.e., [2+3] cycloadditions), nitrone-olefin cycloadditions (i.e., [3+2] cycloadditions), [4+1] cycloadditions, [4+3] cycloadditions, [6+4] cycloadditions, [2+2+2] cycloadditions, and the like.

In an embodiment, the thermally cleavable surfactant comprises a Diels-Alder reaction product. Hereinafter the disclosure will refer to the transiently functional additive as a Diels-Alder reaction product although it is to be understood that other compounds or cycloaddition reaction products (e.g., “click-chemistry”-type additions) are also contemplated. Diels-Alder reactions generally refer to [4+2] cycloaddition reactions that occur between a conjugated diene and a dienophile (e.g., a substituted alkene). This general reaction is presented in Scheme I.

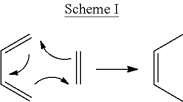

As Diels-Alder reactions are reversible, the thermally cleavable surfactant can undergo what is termed a retro Diels-Alder or cycloreversion reaction wherein the diene and dienophile are reformed.

In an embodiment, the diene comprises an aromatic cyclic ether. In an embodiment, the aromatic cyclic ether comprises a furan, benzofuran, isobenzofuran, dibenzofuran, cyclopentadiene, or derivatives thereof. In an embodiment, the diene comprises an alkylfuran where the alkyl group has from about 8 to about 20 carbon atoms.

In an embodiment, the dienophile comprises an unsaturated imide. Alternatively, the dienophile comprises a substituted unsaturated imide, alternatively a maleimide-containing compound, alternatively maleimide.

In an embodiment, the diene (e.g., furan), dienophile (e.g., maleimide) or both are substituted. Substitution of the diene and/or dienophile may result in a Diels-Alder adduct having some user and/or process desired head and/or tail group. In an embodiment, the tail group comprises an alkyl chain. The alkyl chain may be characterized by the general formula CₙH₂ₙ where n may be from about 6 to about 24, alternatively from about 6 to about 20, or alternatively from about 6 to about 18. In an alternative embodiment, the alkyl chain comprises from about 6 to about 24 carbon atoms, alternatively from about 6 to about 20 carbon atoms or alternatively from about 6 to about 18 carbon atoms and is unsaturated (i.e., the alkyl chain contains at least one double or triple bond).

In an embodiment, the head group is anionic and comprises a carboxylic acid salt, amine salt, sulfonic acid salt, sulfosuccinate ester, sulfuric acid ester, sulfated polyethylenated alcohol, sulfated triglyceride oils, phosphoric or polyphosphoric acid ester or combinations thereof. In an embodiment the head group is cationic and comprises quartenary ammonium salts, amine salts, amine oxides or combinations thereof. In an embodiment, the head group is nonionic and comprises alkylphenol ethoxylates, linear and branched alcohol ethoxylates, glycol, mercaptans, esters, alkanolamines, tertiary acetylenic glycols, pyrrolidones, alkyl glycosides, zwitterionic groups or combinations thereof. In some embodiments, the tail group is attached to the diene and the headgroup is attached to the dienophile. In some embodiments, the tail group is attached to the dienophile and the head group is attached to the diene.

In an embodiment, the diene comprises furan and the dienophile comprises maleimide. In such embodiments, the furan may be an alkylfuran of the type prepared as generally described by Piancatelli, et al., (Tetrahedron, v. 36, pp. 661-663, herein incorporated by reference) by a reaction between furan and an alkyl bromide molecule in a solution of n-butyl lithium and THF. In such embodiments, the maleimide may be of the type prepared as described by Park, et al., (Poly. Sci. Part A: Poly. Chem., v. 30 (1992) pp. 723-729, herein incorporated by reference) by a condensation reaction to provide either a phenolated or a carboxylated maleimide. The Diels-Alder reaction of a furan (i.e., diene) and a maleimide (i.e., dienophile) is presented in Scheme II. In Structure A or Structure C the alkyl group may be C8 to C20 saturated or unsaturated group while in Structure B or Structure C the R group may be SO₃Na, OH, or ethoxylated. The resulting reaction product (e.g., Structure C) is herein designated a Diels-Alder surfactant (DAS).

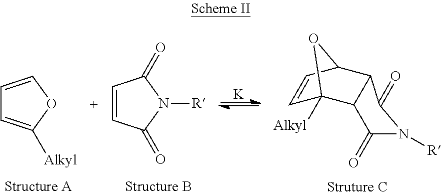

The DAS disclosed herein may be utilized as prepared. It is to be understood that the DAS when utilized as prepared may contain some level of impurities attributable to unreacted starting materials, the products of unwanted side reactions and the like. Thus, the DAS when utilized as prepared may contain a reaction product having surfactant activity that constitutes equal to or greater than about 55%, 60%, 65%, 70%, 75%, 80%, 85%, 90%, 95%, or 99% of the total amount of reaction product. Alternatively, the DAS prepared as described herein is subjected to one or more purification techniques designed to provide a composition having an increased amount of the reaction product having surfactant activity when compared to the original reaction product. The DAS may be subjected to any suitable purification technique or methodology may be employed to increase the purity of the DAS reaction product having surfactant activity and/or to generate a composition having an increased amount of the reaction product having surfactant activity when compared to the original reaction product.

In an embodiment, the thermally cleavable surfactant comprises a DAS. The DAS may be introduced into a wellbore servicing fluid and function to provide surfactant activity at a sufficient level and for a sufficient time period to accomplish one or more user and/or process desired and/or designated goals. In an embodiment, subsequent to performing the intended function of the DAS in the wellbore servicing fluid, the material undergoes a retro-Diels-Alder reaction to form materials lacking appreciable surfactant activity. In some embodiments, the DAS undergoes a retro Diels-Alder reaction under ambient wellbore conditions with temperatures ranging from about 80° C. to about 250° C. to form materials that lack surfactant activity. Alternatively, the DAS undergoes a retro Diels-Alder reaction under ambient wellbore conditions with temperatures ranging from about 80° C. to about 250° C. to form materials that exhibit a reduced amount of surfactant activity when compared to the DAS. In an embodiment, the retro Diels-Alder reaction is a reaction that occurs at temperatures greater than about 60° C. It is contemplated that adjustments in the thermal stability of the DAS, or the temperature at which the material undergoes the retro Diels-Alder reaction, may be made by adjusting the type of substituents present on the diene and/or dienophile. Such adjustments may be carried out by one of ordinary skill in the art with the benefits of this disclosure. Preparation of thermally cleavable surfactants is described in more detail in U.S. Pat. Nos. 7,622,596; 7,593,349; 7,378,533; 7,351,837; and 7,022,861 each of which is incorporated by reference herein in its entirety.

The DAS disclosed herein may be included in any suitable wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. It is to be understood that “subterranean formation” encompasses both areas below exposed earth and areas below earth covered by water such as ocean or fresh water. Examples of servicing fluids include, but are not limited to, cement slurries, drilling fluids or muds, workover fluids, packer fluids, spacer fluids, fracturing fluids or completion fluids.

In an embodiment, the wellbore servicing fluid comprises a consolidation fluid. Consolidation fluids are used for controlling particulates in unconsolidated subterranean zones which contain loose particulates that may abrade wellbore servicing equipment and otherwise detrimentally impact a wellbore servicing operation. Consolidation fluids typically contain resins or tackifiers and surfactants that function to emulsify the resin or tackifier. Surfactants present in the consolidation fluid may inhibit the extent to which the resin or tackifier adheres to the desired surfaces (e.g., sand, formation, etc.). Additionally, in some instances, surfactants may destabilize a coating (e.g., resin or tackifying agent) on a surface within a subterranean formation or a surface of a proppant particulate (e.g., as contained in and/or placed with a fracturing fluid), for example, by forming surfactant micelles within the coating and/or making the coating less dense. In other instances, it may be desirable to deposit molecules of a surfactant on a surface within a subterranean formation and/or a surface of a proppant particulate, for example, when the proppant particulate is to be treated with certain aqueous tackifying agents. However, conventional surfactants may not distribute themselves evenly along the coating, which may leave certain portions of a subterranean formation or a proppant particulate insufficiently treated with the surfactant for particular subterranean operations. The use of a transiently functional additive (i.e., DAS) may reduce and/or eliminate the potential interference of the surfactant with the function of the resin and/or tackifier. In an embodiment, the WSF comprises a consolidating fluid and a DAS of the type disclosed herein.

In an embodiment the wellbore servicing fluid is a drilling fluid comprising an emulsion or an invert-emulsion. In an embodiment, the wellbore servicing fluid comprises an oil-in-water emulsion fluid comprising a non-oleaginous (e.g., aqueous) continuous phase and an oleaginous discontinuous phase. In an embodiment, the wellbore servicing fluid comprises a water-in-oil emulsion fluid, termed an invert emulsion, comprising an oleaginous continuous phase and a non-oleaginous discontinuous phase. Examples of oleaginous fluids suitable for use in drilling fluids include, but are not limited to petroleum oils, natural oils, synthetically-derived oils, or combinations thereof. More particularly, examples of oleaginous fluids suitable for use in drilling fluids include, but are not limited to, diesel oil, kerosene oil, mineral oil, synthetic oil, such as polyolefins (e.g., alpha-olefins and/or internal olefins), polydiorganosiloxanes, esters, diesters of carbonic acid, paraffins, or combinations thereof.

Any aqueous solution compatible with the other components of the wellbore servicing fluid may comprise the non-oleaginous phase. In an embodiment, the aqueous solution may generally comprise any suitable aqueous liquid. Examples of suitable aqueous fluids include, but are not limited to, sea water, freshwater, naturally-occurring and artificially-created brines containing organic and/or inorganic dissolved salts, liquids comprising water-miscible organic compounds, and combinations thereof.

In an embodiment, the DAS may be used to viscosify a WSF such as a fracturing fluid, gravel packing fluid, fluid loss control pills, and drilling fluids. In an embodiment, the WSF comprises a fracturing fluid. As will be understood by one of ordinary skill in the art, the particular composition of a fracturing fluid will be dependent on the type of formation that is to be fractured. Fracturing fluids in addition to surfactants typically comprise an aqueous fluid (e.g., water), a particulate material (e.g., sand), acid, friction reducers, gelling agents, scale inhibitors, pH-adjusting agents, oxygen scavengers, breakers, crosslinkers, iron-control agents, corrosion inhibitors, bactericides and the like.

In an embodiment, the WSF comprises a completion fluid. Completion fluids are fluids used during the process to prepare a well for production. In an embodiment, the completion fluid comprises a solids-free brine.

The WSF that a particular DAS of the type disclosed herein may be included in depends on a variety of factors. These factors may include, but are not limited to, the choice of the hydrophobic and hydrophilic portions and the relative amounts thereof in the DAS, and the presence of any cationic, anionic, non-ionic, amphoteric, or zwitterionic groups. For example, whether an oil-in-water or water-in-oil emulsion is formed may be determined by the relative hydrophobicity of the tail and the hydrophilicity of the hydrophilic unit or head group of the DAS. The hydrophilic/lipophilic balance (“HLB”) of the DAS may provide a quantitative prediction of whether the DAS will facilitate the formation of an oil-in-water or water-in-oil emulsion. By varying at least some of these factors, the specific properties of the DAS such as solubility, wettability, emulsifying, foaming, antifoaming, cloud point, gelling, solubilizing capacity, and the like may be varied. For example, where used as an emulsifying agent, a DAS having an HLB of from about 3 to about 6 may be suitable to stabilize a water-in-oil emulsion. In other embodiments, where used as an emulsifying agent, a DAS having an HLB of from about 8 to about 18 may be suitable to stabilize an oil-in-water (or invert) emulsion. Those of ordinary skill in the art, with the benefit of this disclosure, will be able to determine the appropriate DAS to use for a particular application.

In an embodiment, a DAS of the type disclosed herein is present in a WSF in an amount effective to perform the intended function of the surfactant. The DAS may be present in amounts ranging from about 0.001% weight percent (wt. %) to about 10% wt. %, alternatively from about 0.01 wt. % to about 8 wt. %, or alternatively from about 0.1 wt. % to about 5 wt. %.

In an embodiment, a DAS of the type disclosed herein may be included in a WSF which is placed downhole and used in a wellbore servicing operation. The DAS may provide surfactant activity for some period of time sufficient to perform its intended function in the WSF. Thereafter the surfactant activity of the DAS may be reduced and/or lost after the DAS is subjected to ambient wellbore conditions (e.g. temperatures of the range disclosed herein). The loss of the surfactant activity of the DAS in situ in the wellbore (e.g., above certain temperatures) may confer a number of advantages to the wellbore servicing operation. In some embodiments, the DAS is used in a WSF to stabilize an emulsion. In such embodiments, thermal cleavage of the DAS and the loss of surfactant activity may result in the breaking of these emulsions which would reduce the tendency of these emulsions to plug the formation and thereby reduce the tendency of such materials to reduce the permeability of the formation. In some embodiments, the DAS is used in WSF comprising resins that are to be placed in unconsolidated areas of the subterranean formation. In such embodiments, thermal cleavage of the DAS and the loss of surfactant activity may reduce the extent to which the surfactant inhibits the adherence of the resin to surfaces within the formation. In an embodiment the DAS when included in a WSF does not substantially alter the wettability of the formation to which it is introduced. For example, a quaternary amine surfactant may change the surface wettability of the formation (e.g., pores, fractures, fissures) from water-wet to oil-wet, which may be undesirable. For instance, this change in wettability can be beneficial for the production of one phase (e.g., oil) and may not be better for the other phase (e.g., water), and there is a chance of the formation of a block (oil or water) in the pores when the formation encounters the other phase. In an embodiment, thermal cleavage of the DAS and the loss of surfactant activity may reduce the extent to which the surfactant influences the wettability of the surface of the formation.

WSFs comprising a DAS may be prepared at a job site, or they may be prepared at a plant or facility prior to use, and may be stored for some period of time prior to use. In certain embodiments, the preparation of these fluids may be done at the job site in a method characterized as being performed “on-the-fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

A WSF comprising a DAS of the type disclosed herein may be prepared and/or used in any subterranean operation wherein a fluid may be used requiring the transiently functional properties described herein. Suitable subterranean operations may include, but are not limited to, drilling operations, hydraulic fracturing treatments, sand control treatments (e.g., gravel packing), acidizing treatments (e.g., matrix acidizing or fracture acidizing), “frac-pack” treatments, well bore clean-out treatments, and other suitable operations.

### Additional Disclosure

The following are nonlimiting, specific embodiments in accordance with the present disclosure:

A first embodiment, which is a method of servicing a wellbore, comprising:
placing a wellbore servicing fluid comprising a transiently functional additive into a wellbore, wherein the transiently functional additive is a Diels-Alder reaction product.

A second embodiment, which is the method of embodiment 1 wherein the transiently functional additive comprises a surfactant.

A third embodiment, which is the method of the first or second embodiment wherein the Diels-Alder reaction product is formed from the reaction of a diene and a dienophile.

A fourth embodiment, which is the method of the third embodiment wherein the diene comprises an aromatic cyclic ether.

A fifth embodiment, which is the method of the fourth embodiment wherein the aromatic cyclic ether comprises a furan, an alkyl furan, benzofuran, isobenzofuran, dibenzofuran, cyclopentadiene, or derivatives thereof.

A sixth embodiment, which is the method of the fifth embodiment wherein the alkyl furan comprises an alkyl group having from about 8 to about 20 carbon atoms.

A seventh embodiment, which is the method of any of the third through the sixth embodiments wherein the dienophile comprises an unsaturated imide.

An eighth embodiment, which is the method of any of the third through seventh embodiments wherein the diene comprises furan and the dienophile comprises maleimide.

A ninth embodiment, which is the method of any of the first through eighth embodiments wherein the transiently functional additive is thermally cleavable.

A tenth embodiment, which is the method of any of the first through eighth embodiments wherein the transiently functional additive degrades in a temperature range of from about 80° C. to about 250° C.

An eleventh embodiment, which is the method of any of the first through tenth embodiments wherein degradation of the transiently functional additive comprises a retro Diels-Alder reaction.

A twelfth embodiment, which is the method of any preceding embodiments wherein the wellbore servicing fluid comprises a consolidation fluid, a drilling fluid, a fracturing fluid, a completion fluid, a workover fluid, a packer fluid, a spacer fluid, or combinations thereof.

A thirteenth embodiment, which is the method of any preceding embodiments wherein the transiently function additive is present in the wellbore servicing fluid in an amount of from about 0.001 wt. % to about 10 wt. % based on the total weight of the wellbore servicing fluid.

A fourteenth embodiment, which is a method of servicing a wellbore comprising placing into a wellbore a wellbore servicing fluid comprising the reaction product of furan and maleimide.

A fifteenth embodiment, which is the method of the fourteenth embodiment wherein the wellbore servicing fluid comprises a consolidation fluid, a drilling fluid, a fracturing fluid, a completion fluid, a workover fluid, a packer fluid, a spacer fluid, or combinations thereof.

A sixteenth embodiment, which is the method of the fifteenth embodiment wherein the drilling fluid comprises an invert emulsion.

A seventeenth embodiment, which is the method of any of the fourteenth, fifteenth or sixteenth embodiment wherein the reaction product of furan and maleimide degrades in a temperature range of from about 80° C. to about 250° C.

An eighteenth embodiment, which is the method of any of the fourteenth, fifteenth, sixteenth or seventeenth embodiment wherein the reaction product of furan and maleimide is present in the wellbore servicing fluid in an amount of from about 0.001 wt. % to about 10 wt. % based on the total weight of the wellbore servicing fluid.

A nineteenth embodiment, which is the method of any of the fourteenth through eighteenth embodiments wherein degradation of the reaction product of furan and maleimide comprises a retro Diels-Alder reaction.

A twentieth embodiment, which is a consolidation fluid comprising a resin and the reaction product of furan and maleimide.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+kl*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method of servicing a wellbore, comprising:
placing a wellbore servicing fluid comprising a transiently functional additive into a wellbore, wherein the transiently functional additive is a Diels-Alder reaction product.

2. The method of claim 1 wherein the transiently functional additive comprises a surfactant.

3. The method of claim 1 wherein the Diels-Alder reaction product is formed from the reaction of a diene and a dienophile.

4. The method of claim 3 wherein the diene comprises an aromatic cyclic ether.

5. The method of claim 4 wherein the aromatic cyclic ether comprises a furan, an alkyl furan, benzofuran, isobenzofuran, dibenzofuran, cyclopentadiene, or derivatives thereof.

6. The method of claim 5 wherein the alkyl furan comprises an alkyl group having from about 8 to about 20 carbon atoms.

7. The method of claim 3 wherein the dienophile comprises an unsaturated imide.

8. The method of claim 3 wherein the diene comprises furan and the dienophile comprises maleimide.

9. The method of claim 1 wherein the transiently functional additive is thermally cleavable.

10. The method of claim 1 wherein the transiently functional additive degrades in a temperature range of from about 80° C. to about 250° C.

11. The method of claim 10 wherein degradation of the transiently functional additive comprises a retro Diels-Alder reaction.

12. The method of claim 1 wherein the wellbore servicing fluid comprises a consolidation fluid, a drilling fluid, a fracturing fluid, a completion fluid, a workover fluid, a packer fluid, a spacer fluid, or combinations thereof.

13. The method of claim 1 wherein the transiently function additive is present in the wellbore servicing fluid in an amount of from about 0.001 wt. % to about 10 wt. % based on the total weight of the wellbore servicing fluid.

14. A method of servicing a wellbore comprising placing into a wellbore a wellbore servicing fluid comprising the reaction product of furan and maleimide.

15. The method of claim 14 wherein the wellbore servicing fluid comprises a consolidation fluid, a drilling fluid, a fracturing fluid, a completion fluid, a workover fluid, a packer fluid, a spacer fluid, or combinations thereof.

16. The method of claim 15 wherein the drilling fluid comprises an invert emulsion.

17. The method of claim 14 wherein the reaction product of furan and maleimide degrades in a temperature range of from about 80° C. to about 250° C.

18. The method of claim 14 wherein the reaction product of furan and maleimide is present in the wellbore servicing fluid in an amount of from about 0.001 wt. % to about 10 wt. % based on the total weight of the wellbore servicing fluid.

19. The method of claim 18 wherein degradation of the reaction product of furan and maleimide comprises a retro Diels-Alder reaction.

20. A consolidation fluid comprising a resin and the reaction product of furan and maleimide.
